(19) United States
(12) Patent Application Publication
(10) Pub. No.: US 2023/0203401 A1
(43) Pub. Date: Jun. 29, 2023

(54) Cleaning Compositions

(71) Applicant: Colgate-Palmolive Company, New York, NY (US)

(72) Inventors: Luis Javier RIVERA CRUZ, Mexico City (MX); Jorge Antonio MALDONADO ORTEGA, Delegacion Miguel Hidalgo CP (MX); Erick CARDENAS ALPIZAR, Mexico City (MX); Jose BUCIO, Guanajuato (MX)

(73) Assignee: Colgate-Palmolive Company, New York, NY (US)

(21) Appl. No.: 18/085,249

(22) Filed: Dec. 20, 2022

Related U.S. Application Data
(60) Provisional application No. 63/293,490, filed on Dec. 23, 2021.

(51) Int. Cl. C11D 1/94; C11D 3/43; C11D 3/20; C11D 11/00

(52) U.S. Cl. CPC C11D 1/94; C11D 3/43; C11D 3/2048; C11D 3/2044; C11D 11/0023; C11D 1/29

(57) ABSTRACT

Disclosed herein are cleaning compositions, e.g., dishwashing compositions, comprising one or more anionic surfactants comprising sodium laureth sulfate (SLES), one or more amphoteric surfactants, and an additive selected from caprylyl glycol, ethanol, and a combination thereof, wherein the composition contains less than 1 ppm. The cleaning compositions may further comprise a linear alkylbenzene sulfonate (LAS). Methods of making and cleaning a hard surface using such compositions are also provided.

### BACKGROUND

Sodium laureth sulfate (SLES) is an anionic surfactant which is widely used in cleaning products as a primary surfactant. In addition to excellent detergency, it also has excellent emulsification and foamability. SLES is prepared by ethoxylation of dodecyl alcohol produced from palm kernel oil or coconut oil, followed by the sulfation of the resulting ethoxylate and neutralization to the sodium salt. 1,4-dioxane is formed as a by-product during the ethoxylation step. Therefore, cleaning products containing SLES contain trace amounts of 1,4-dioxane.

1,4-dioxane is a likely carcinogen. 1,4-dioxane is very stable and does not degrade naturally. Furthermore, it is not possible to eliminate 1,4 dioxane in the processes of treating water. It has been recognized that the usage of cleaning products containing SLES has impact on ground-water contamination. The United States Food and Drug Administration (FDA) recommends that the level of 1,4-dioxane in products be monitored and encourages manufacturers to remove 1,4-dioxane. New York is banning the sale of household cleaning and personal care products containing more than 2 ppm 1,4-dioxane at the end of 2022 and more than 1 ppm at the end of 2023.

Thus, there is a need for 1,4-dioxane safe cleaning products containing SLES.

### BRIEF SUMMARY

In an aspect, the invention provides a cleaning composition, e.g., a dishwashing composition, comprising one or more anionic surfactants comprising sodium laureth sulfate (SLES), one or more amphoteric surfactants, and an additive selected from caprylyl glycol, ethanol, and a combination thereof, wherein the composition contains less than 1 ppm, e.g., less than 0.5 ppm, or less than 0.1 ppm, 1,4-dioxane.

In some embodiments, the sodium laureth sulfate (SLES) has an average degree of ethoxylation of less than 1, e.g., from 0.2 to 0.7, from 0.2 to 0.6, from 0.2 to 0.5, from 0.4 to 0.7, from 0.4 to 0.6, from 0.4 to 0.5, or about 0.45. In some embodiments, the SLES is SLES 0.45 EO (SLES having an average degree of ethoxylation of about 0.45). In some embodiments, the SLES is present in an amount of from 1% to 10%, e.g., from 3% to 10%, from 5% to 10%, from 6% to 10%, or from 7% to 10%, by weight of the composition.

In some embodiments, the one or more anionic surfactants further comprise a linear alkylbenzene sulfonate (LAS). In some embodiments, the LAS is sodium dodecylbenzene sulfonate (NADDBS). In some embodiments, the LAS (e.g., NADDBS) is present in an amount of from 1% to 35%, e.g., from 2% to 35%, from 2% to 10%, from 2% to 7%, from 10% to 35%, from 25% to 35%, or from 30% to 35%, by weigh of the composition.

In some embodiments, the weight ratio of the one or more anionic surfactants to the one or more amphoteric surfactants is from 3:1 to 4:1, e.g., from 3.2:1 to 3.8:1, from 3.3:1 to 3.7:1, from 3.4:1 to 3.6:1, or about 3.5:1.

In some embodiments, the one or more amphoteric surfactants is selected from LMDS (lauryl/myristyl amidopropyl dimethylamine oxide), LAPB (lauryl amido propyl betaine), and a combination thereof. In some embodiments, the one or more amphoteric surfactants is LMDS and the composition has a pH of from 6.5 to 8.5, e.g., from 7 to 8, or about 7.5. In some embodiments, LMDS is present in an amount of from 2% to 5%, e.g., from 2 to 4%, from 2% to 3%, or from 2% to 2.5%, by weight of the composition. In other embodiments, the one or more amphoteric surfactants is LAPB and the composition has a pH of from 3.5 to 8.5, e.g., from 3.5 to 7, from 3.5 to 6, from 3.5 to 5, from 3.5 to 4.5, from 3.5 to 4, or about 3.5. In some embodiments, LAPB is present is an amount of from 2% to 5%, e.g., from 3 to 5%, from 3.5% to 5%, or from 3.5% to 4.6%, by weight of the composition.

In some embodiments, the additive selected from caprylyl glycol, ethanol, and a combination thereof is present in an amount of from 0.1% to 3%, e.g., from 0.2% to 2%, from 0.3 to 1%, from 0.5% to 2.3%, or from 0.5% to 0.75%, by weight of the composition.

In another aspect, the invention provides a method of cleaning a hard surface, e.g., dish, comprising applying a neat or diluted form of a cleaning composition as disclosed herein to the surface and rinsing the surface with water.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

FIG. 1 shows viscosity flow curves of SLES 0.45EO and SLES 1 EO over the shear rate at 30° C. and 40° C.

FIG. 2 shows viscosity flow curves of SLES 0.45EO and SLES 1 EO over the shear rate at 10° C. and 20° C.

FIG. 3 shows viscosity flow curves of SLES 0.45EO and SLES 0.45EO+Caprylyl glycol over the shear rate at 10° C. and 20° C.

FIG. 4 shows viscosity flow curves of SLES 0.45EO and SLES 0.45EO+ethanol over the shear rate at 10° C. and 20° C.

### DETAILED DESCRIPTION

The following description of the preferred embodiment(s) is merely exemplary in nature and is in no way intended to limit the disclosure, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

Unless otherwise specified, all percentages and amounts expressed herein and elsewhere in the specification should be understood to refer to percentages by weight. The amounts given are based on the active weight of the material.

The invention relates to 1,4-dioxane safe cleaning products, e.g., dishwashing compositions, comprising sodium laureth sulfate (SLES). The chemical formula of SLES is CH₃(CH₂)₁₁(OCH₂CH₂)ₙOSO₃Na. SLES is heterogeneous in the number of ethoxyl groups. The average degree of ethoxylation can be specified in the name. For example, SLES 1EO refers to SLES having an average degree of ethoxylation of 1. SLES raw materials contain trace amounts of 1,4-dioxane which is formed as a by-product during the ethoxylation step. The higher the number of ethoxyl groups is, the higher level of 1,4-dioxane SLES raw materials contain. For example, SLES 1EO (SLES having an average degree of ethoxylation of 1) and SLES 2EO (SLES having an average degree of ethoxylation of 2) contain about 25-50 ppm 1,4-dioxane. If 7-18% of these materials are contained in dishwashing compositions, the compositions will contain more than 1 ppm 1,4-dioxane. An approach to eliminate or reduce 1,4-dioxane in dishwashing compositions is to use sodium lauryl sulfate (without ethoxylation) instead of SLES. However, the stability of dishwashing compositions containing sodium lauryl sulfate (SLS) at low temperature is poor and user's hands get irritated after washing dishes with SLS formulations.

The level of 1,4-dioxane in cleaning compositions can be reduced to a safe level by using SLES having low degrees of ethoxylation (e.g., SLES 0.45EO), which contains low amounts of 1,4-dioxane. For example, SLES 0.45EO contains about 10 ppm 1,4-dioxane. If no more than 10% SLES 0.45EO is used in cleaning compositions, the level of 1,4-dioxane in the compositions can be maintained below 1 ppm. However, SLES raw materials having low degrees of ethoxylation become solid with wax-like texture below 30° C. The handling of the raw materials would be a problem if all the pipes from the storage tanks to the manufacturing lines were not well heat traced. It has been found that the addition of an additive such as caprylyl glycol and ethanol to SLES raw materials having low degrees of ethoxylation improves the flowability of the raw materials. Thus, a blend of SLES having low degrees of ethoxylation (e.g., SLES 0.45EO) and an additive such as caprylyl glycol and ethanol can be used to reduce the amount of 1,4-dioxane in cleaning compositions to a safe level, e.g., below 1 ppm.

The invention provides, in an aspect, a cleaning composition (Composition 1.0), e.g., a dishwashing composition, comprising one or more anionic surfactants comprising sodium laureth sulfate (SLES), one or more amphoteric surfactants, and an additive selected from caprylyl glycol, ethanol, and a combination thereof, wherein the composition contains less than 1 ppm (or from 0.001 ppm to 1 ppm) 1,4-dioxane.

For example, the invention includes:
1.1. Composition 1.0, wherein the composition contains less than 0.8 ppm, less than 0.5 ppm, less than 0.1 ppm, from 0.001 ppm to 0.8 ppm, from 0.001 ppm to 0.5 ppm, or from 0.001 ppm to 0.1 ppm, 1,4-dioxane.
1.2. Composition 1.0 or 1.1, wherein the SLES has an average degree of ethoxylation of less than 1, e.g., from 0.2 to 0.7, from 0.2 to 0.6, from 0.2 to 0.5, from 0.4 to 0.7, from 0.4 to 0.6, from 0.4 to 0.5, or about 0.45.
1.3. Any of preceding compositions, wherein the SLES is SLES 0.45 EO (SLES having an average degree of ethoxylation of about 0.45).
1.4. Any of preceding compositions, wherein the SLES is present in an amount of from 1% to 10%, e.g., from 3% to 10%, from 5% to 10%, from 6% to 10%, or from 7% to 10%, by weight of the composition.
1.5. Any of preceding compositions, wherein the one or more anionic surfactants is SLES and does not contain any other anionic surfactant.
1.6. Any of preceding compositions, wherein the one or more anionic surfactants further comprise a linear alkylbenzene sulfonate (LAS), optionally wherein the LAS is sodium dodecylbenzene sulfonate (NADDBS).
1.7. Any of preceding compositions, wherein the LAS (e.g., NADDBS) is present in an amount of from 1% to 35%, e.g., from 2% to 35%, from 2% to 10%, from 2% to 7%, from 10% to 35%, from 25% to 35%, or from 30% to 35%, by weigh of the composition.
1.8. Any of preceding compositions, wherein the total amount of the one or more anionic surfactants is from 5% to 20%, e.g., from 5% to 17%, or from 7% to 17%, by weight of the composition.
1.9. Any of preceding compositions, wherein the weight ratio of the one or more anionic surfactants to the one or more amphoteric surfactants is from 3:1 to 4:1, e.g., from 3.2:1 to 3.8:1, from 3.3:1 to 3.7:1, from 3.4:1 to 3.6:1, or about 3.5:1.
1.10. Any of preceding compositions, wherein the weight ratio of the one or more anionic surfactants to the one or more amphoteric surfactants is 3.5:1.
1.11. Any of preceding compositions, wherein the one or more amphoteric surfactants are selected from LMDS (lauryl/myristyl amidopropyl dimethylamine oxide), LAPB (lauryl amido propyl betaine), and a combination thereof.
1.12. Any of preceding compositions, wherein the one or more amphoteric surfactants is LMDS, optionally wherein the pH of the composition is from 6.5 to 8.5, e.g., from 7 to 8, or about 7.5, further optionally wherein LMDS is present in an amount of from 2% to 5%, e.g., from 2 to 4%, from 2% to 3%, or from 2% to 2.5%, by weight of the composition.
1.13. Any of preceding compositions, wherein the one or more amphoteric surfactants is LAPB, optionally wherein the pH of the composition is from 3.5 to 8.5, e.g., from 3.5 to 7, from 3.5 to 6, from 3.5 to 5, from 3.5 to 4.5, from 3.5 to 4, or about 3.5, further optionally wherein LAPB is present is an amount of from 2% to 5%, e.g., from 3 to 5%, from 3.5% to 5%, or from 3.5% to 4.6%, by weight of the composition.
1.14. Any of preceding compositions, wherein the composition further comprises a nonionic surfactant.
1.15. Any of preceding compositions, wherein the additive is present in an amount of from 0.1% to 3%, e.g., from 0.2% to 2%, from 0.3 to 1%, from 0.5% to 2.3%, or from 0.5% to 0.75%, by weight of the composition.
1.16. Any of preceding compositions, wherein the additive is caprylyl glycol, optionally wherein caprylyl glycol is present in an amount of from 0.1% to 3%, e.g., from 0.2% to 2%, from 0.3 to 1%, from 0.5% to 2.3%, or from 0.5% to 0.75%, by weight of the composition.
1.17. Any of preceding compositions, wherein the additive is ethanol, optionally wherein ethanol is present in an amount of from 0.1% to 3%, e.g., from 0.2% to 2%, from 0.3 to 1%, from 0.5% to 2.3%, or from 0.5% to 0.75%, by weight of the composition.
1.18. Any of preceding compositions, wherein the composition comprises water, optionally wherein water is present in an amount of from 40% to 90%, e.g., from 45% to 85%, from 50% to 80%, or from 55% to 75%, by weight of the composition.
1.19. Any of preceding compositions, wherein the composition comprises 7-10% SLES 0.4-0.6 EO (e.g., 0.45 EO), 2-7% NADDBS, 2-2.5% LMDS, 0.5-2.3% additive selected from caprylyl glycol, ethanol, and a combination thereof, by weight of the composition.
1.20. Any of preceding compositions, wherein the composition comprises 7-10% SLES 0.4-0.6 EO (e.g., 0.45 EO), 2-7% NADDBS, 3.5-4.6% LAPB, 0.5-2.3% additive selected from caprylyl glycol, ethanol, and a combination thereof, by weight of the composition.
1.21. Any of preceding compositions, wherein the composition comprises 7-10% SLES 0.4-0.6 EO (e.g., 0.45 EO), 2-2.5% LMDS, 0.5-2.3% additive selected from caprylyl glycol, ethanol, and a combination thereof, by weight of the composition.
1.22. Any of the preceding compositions, further comprising an additional ingredient selected from perfumes or fragrances, dyes or pigments, thickening agents, abrasive agents, disinfectants, radical scavengers, bleaches; buffers, chelating agents, and mixtures thereof.
1.23. Any of the preceding compositions, wherein the composition is a dishwashing composition, e.g., a hand dishwashing composition.

The present invention is directed to cleaning compositions. As used herein, a “cleaning composition” is any composition that may be useful in cleaning substrates, such as household surfaces. A “surface” refers to the surface of any appliance or fixture, and may include hard surfaces such as counters, sinks, cabinets, walls, the surfaces of appliances such as kitchen appliances (e.g., stoves, conventional or microwave ovens, refrigerators, dishwashers and the like), or bathroom appliances and fixtures (e.g., sinks, toilets, bathtubs, tiles, shower curtains and doors), wood or glass surfaces, floors, utensils or dishes, as well as furniture or clothing (including carpets or rugs, cloths, bedding, leather, sponges and mops, polymeric or fabric surfaces or objects made from natural or synthetic materials, e.g., protective gear or sports equipment). The cleaning compositions remove grease efficiently, have homogeneity and clarity, foaming properties, and allow fast drainage with minimal residue. In some embodiments, the cleaning composition is a dishwashing composition, e.g., a hand dish washing corn position.

The cleaning composition of the present invention comprises water. In some embodiments, the composition comprises water in an amount of from 40% to 90%, e.g., from 45% to 85%, from 50% to 80%, or from 55% to 75%, by weight of the composition.

The cleaning composition of the present invention comprises one or more anionic surfactants comprising sodium laureth sulfate (SLES). SLES contains trace amounts of 1,4-dioxane. The level of 1,4-dioxane in the composition can be maintained to a safe level, e.g., below 1 ppm, by using SLES having low degrees of ethoxylation and adjusting the amount of the SLES. For example, the level of 1,4-dioxane in a cleaning composition will be below 1 ppm if no more than 10% SLES 0.4EO, which contains about 1 ppm 1,4-dioxane, is used in the composition. The cleaning composition of the present invention contains less than 1 ppm, or from 0.001 ppm to 1 ppm, 1,4-dioxane. In some embodiments, the composition contains less than 0.8 ppm, less than 0.5 ppm, less than 0.1 ppm, from 0.001 ppm to 0.8 ppm, from 0.001 ppm to 0.5 ppm, or from 0.001 ppm to 0.1 ppm, 1,4-dioxane.

In some embodiments, the SLES contained in the composition has an average degree of ethoxylation of less than 1. In some embodiments, the SLES has an average degree of ethoxylation of from 0.2 to 0.7, from 0.2 to 0.6, from 0.2 to 0.5, from 0.4 to 0.7, from 0.4 to 0.6, from 0.4 to 0.5, or about 0.45. In some embodiments, the amount of SLES in the composition is from 1% to 10%, e.g., from 3% to 10%, from 5% to 10%, from 6% to 10%, or from 7% to 10%, by weight of the composition.

In some embodiments, the total amount of the one of more anionic surfactants is from 5% to 20%, e.g., from 5% to 17%, or from 7% to 17%, by weight of the composition.

In some embodiments, SLES is the sole anionic surfactant and the composition does not contain any other anionic surfactant.

In some embodiments, the one of more anionic surfactants further comprise a linear alkylbenzene sulfonate (LAS). For cleaning compositions which require high levels of anionic surfactants, SLES alone may not reach the requirement of the high levels, because the amount of SLES that can be used in the composition has a maximum limit in order to maintain the level of 1,4-dioxane below 1 ppm. The remaining anionic surfactant required is completed by the addition of a linear alkylbenzene sulfonate (LAS). In certain embodiments, the LAS is sodium dodecylbenzene sulfonate (NADDBS). In some embodiments, the LAS (e.g., NADDBS) is present in an amount of from 1% to 35%, e.g., from 2% to 35%, from 2% to 10%, from 2% to 7%, from 10% to 35%, from 25% to 35%, or from 30% to 35%, by weight of the composition. In some embodiments, the LAS (e.g., NADDBS) is present in an amount of from 2% to 7%, by weight of the composition.

The cleaning composition of the present invention comprises one or more amphoteric surfactants. In some embodiments, the weight ratio of the one or more anionic surfactants to the one or more amphoteric surfactants is from 3:1 to 4:1, e.g., from 3.2:1 to 3.8:1, from 3.3:1 to 3.7:1, from 3.4:1 to 3.6:1, or 3.5:1. In certain embodiments, the ratio of the one or more anionic surfactants to the one or more amphoteric surfactants is 3.5:1.

In some embodiments, the one or more amphoteric surfactants are selected from LMDS (lauryl/myristyl amidopropyl dimethylamine oxide), LAPB (lauryl amido propyl betaine), and a combination thereof. The selection of amphoteric surfactant may be dependent on the pH desired for the cleaning composition. For example, LMDS is used for cleaning compositions with neutral pH, while LAPB is used for cleaning compositions with acidic pH. In some embodiments, the one or more amphoteric surfactants is LMDS, optionally wherein the pH of the composition is from 6.5 to 8.5, e.g., from 7 to 8, or about 7.5. In some embodiments, LMDS is present in an amount of from 2% to 5%, e.g., from 2 to 4%, from 2% to 3%, or from 2% to 2.5%, by weight of the composition. In other embodiments, the one or more amphoteric surfactant is LAPB, optionally wherein the pH of the composition is from 3.5 to 8.5, e.g., from 3.5 to 7, from 3.5 to 6, from 3.5 to 5, from 3.5 to 4.5, from 3.5 to 4, or about 3.5. In some embodiments, LAPB is present is an amount of from 2% to 5%, e.g., from 3 to 5%, from 3.5% to 5%, or from 3.5% to 4.6%, by weight of the composition.

In some embodiments, the composition of the present invention may further comprise a nonionic surfactant. In some embodiments, the nonionic surfactant may comprise a non-ionic block copolymer. The non-ionic block copolymer may be a poly(propylene oxide)/poly(ethylene oxide) copolymer. In some embodiments, the copolymer has a polyoxypropylene molecular mass of from 3000 to 5000 g/mol and a polyoxyethylene content of from 60 to 80 mol %. In some embodiments, the non-ionic block copolymer is a poloxamer. In some embodiments, the non-ionic block copolymer is selected from: Poloxamer 338, Poloxamer 407, Poloxamer, 237, Poloxamer, 217, Poloxamer 124, Poloxamer 184, Poloxamer 185, and a combination of two or more thereof.

The composition of the present invention comprises an additive selected from caprylyl glycol, ethanol, and a combination thereof. These additives improve the processability, e.g., flowability, of SLES having low degrees of ethoxylation (e.g., SLES 0.45EO). In some embodiment, the additive is present in an amount of from 0.1% to 3%, e.g., from 0.2% to 2%, from 0.3 to 1%, from 0.5% to 2.3%, or from 0.5% to 0.75%, by weight of the composition. In some embodiment, the additive is caprylyl glycol, optionally wherein caprylyl glycol is present in an amount of from 0.1% to 3%, e.g., from 0.2% to 2%, from 0.3 to 1%, from 0.5% to 2.3%, or from 0.5% to 0.75%, by weight of the composition. In other embodiments, the additive is ethanol, optionally wherein ethanol is present in an amount of from 0.1% to 3%, e.g., from 0.2% to 2%, from 0.3 to 1%, from 0.5% to 2.3%, or from 0.5% to 0.75%, by weight of the composition.

Additional optional ingredients may be included to provide added effect or to make the product more attractive to the consumer. Such ingredients include, but are not limited to: perfumes or fragrances, dyes or pigments, thickening agents, abrasive agents, disinfectants, radical scavengers, bleaches, buffers, chelating agents, or mixtures thereof.

In another aspect, the invention provides a method of cleaning a hard surface, e.g., dish, comprising applying a neat or diluted form of a cleaning composition disclosed herein, e.g., any of Compositions 1 et seq, to the surface and rinsing the surface with water. As used herein, “applying” may include, for example, spraying, wiping, transferring (as with a sponge or cloth), pouring or the like.

### EXAMPLES

### Example 1

In order to formulate stable 1,4-dioxane safe hand dishwashing formulations, formulations containing sodium lauryl sulfate (SLS) (without ethoxylation) are tested. The stability of the formulations containing SLS is poor at low temperatures. Even after just 6 hours at 4° C., the formulations crystalize and become cloudy. Additionally, user's hands get irritated 24 hours after washing dishes with the SLS formulations.

Next, hand dishwashing formulations containing sodium laureth sulfate (SLES) having various degrees of ethoxylation are tested. Sodium laureth sulfates (SLES) having various degrees of ethoxylation are prepared by blending sodium lauryl sulfate (SLS) and SLES 1 EO (SLES having an average degree of ethoxylation of 1) in different ratios as indicated in Table 1.

TABLE 1

| | SLES 0.1EO | SLES 0.2EO | SLES 0.45EO | SLES 1EO |
|---|---|---|---|---|
| SLS | 90% | 80% | 55% | 0% |
| SLES 1EO | 10% | 20% | 45% | 100% |

The cleaning formulations containing SLES 0.1EO or SLES 0.2 EO crystalize and become cloudy after six hours at 4° C., while the cleaning formulation containing SLES 0.45EO remains clear after 6 hours at 4° C. The stability of the formulation containing SLES 0.45EO is even better than that of the formulation containing SLES 1 EO after 6 hours at 4° C.

### Example 2

In this experiment, SLES 0.45EO is produced by blending 2 ethoxylated alcohols in a ratio of 55:45 lauryl alcohol/lauryl ether alcohol with 1 EO mol. The blend is then sulfated and neutralized using the Ballestra Reactor. The obtained SLES 0.45 EO is stored in a tank to be later pumped to the manufacturing line. When the SLES 0.45 EO raw material is stored in the tank below 30° C., it becomes solid with wax-like texture. It is inconvenient to have this wax-like texture because it is difficult to pump it out of the storage tank and the wax get stuck all over the tubing from the storage tank to the manufacturing line. Although this is not a problem in the final dishwashing product, the handling of the raw material would be a problem if all the pipes were not well heat traced.

In order to better characterize the flowability of SLES, the viscosities of SLES samples are measured by using a TA instrument Rheometer HR3 and a very specific Rheometric Geometry called “double plate cross hatched”.

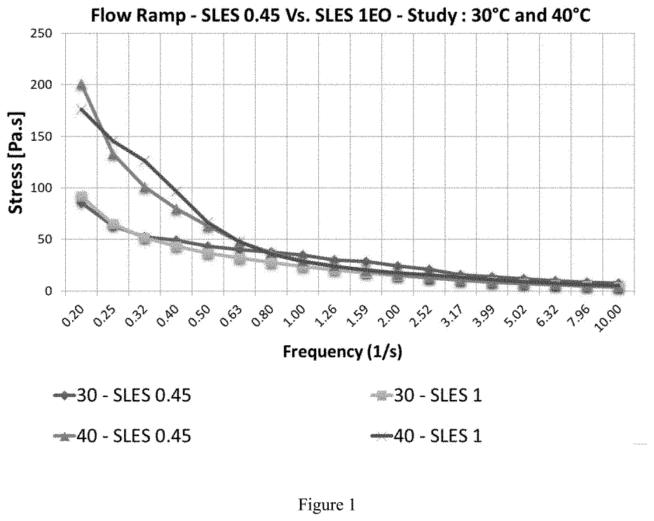

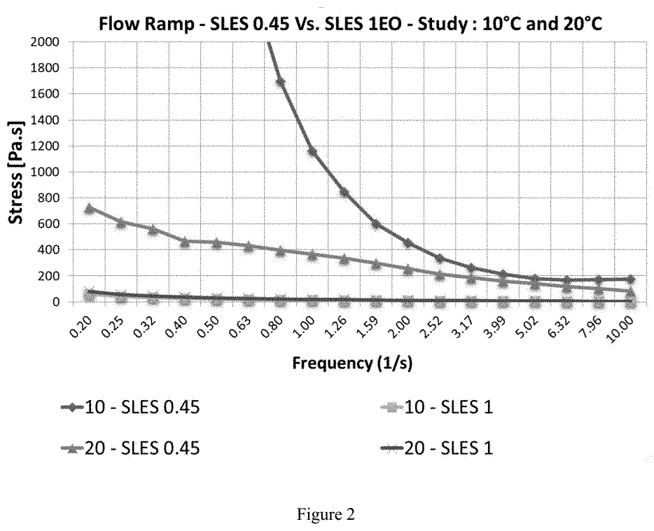

The viscosities of SLES 0.45EO and SLES 1 EO at different temperatures and different shear rates are measured. The results are shown in FIGS. 1 and 2. As shown in FIG. 1, both SLES 0.45EO and SLES 1 EO are pseudoplastic with shear and temperature thinning at above 30° C. However, when the ramps are conducted at 10° C. and 20° C., SLES 0.45EO does not behave the same as SLES 1EO (FIG. 2). At 20° C., the viscosity of SLES 0.45EO at small shear rates becomes around 4 times more viscous and at 10° C., the viscosity of SLES 0.45EO increases exponentially (around 50 times more viscous) as the shear rate decreases, showing the wax like appearance. These results confirms that SLES 0.45 EO can be manageable if the handling temperature is above 30° C., while below the temperature, the handling of SLES 0.45 EO is a problem especially for low shear rates below 120 RPM.

Several additives are tested for their effect on the flowability of SLES 0.45EO. SLES 0.45EO samples are heated above 30° C. and are manually blended with 1, 2, 3 and 5% of tested additives. The samples are left at room temperature for 24 hours and assessed visually to determine the potential for flowability improvements. The results are shown in Table 2. Caprylyl glycol (CapG) and ethanol improves the flowability of SLES 0.45EO, while other tested additives do not improve flowability of SLES 0.45EO (PEG, Neodol, Pluronic L44) or show only slight improvement (DPNB, phenoxyethanol).

TABLE 2

| | CapG | Ethanol | DPNB | Phenoxyethanol | Propanediol | PEG | Neodol | Pluronic L44 |
|---|---|---|---|---|---|---|---|---|
| SLES | +++ | ++ | + | + | − | − | − | − |
| 0.45EO | >5% | >5% | | | Still solid | Still solid | Still solid | Still solid |
| | | | | | at RT | at RT | at RT | at RT |

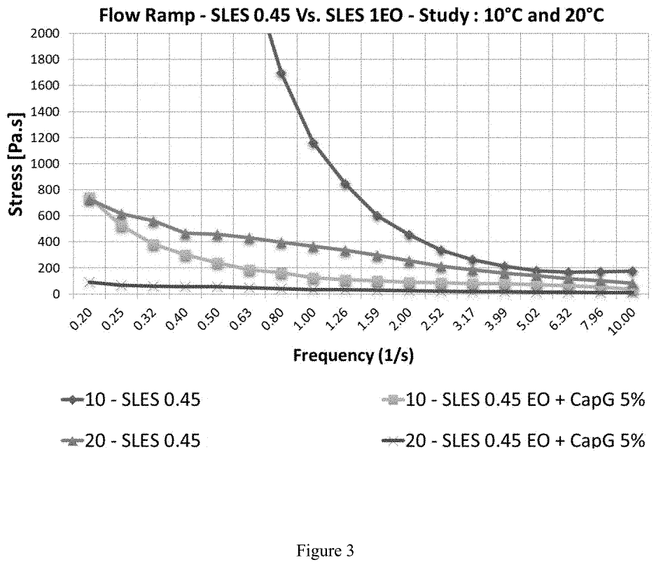

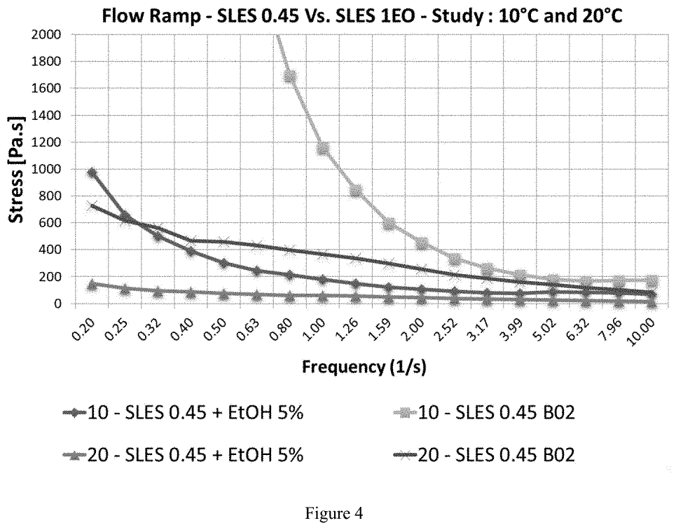

In order to assess the effect of caprylyl glycol and ethanol on the flowability of SLES 0.45 EO more accurately, the viscosities of SLES 0.45 EO samples with or without caprylyl glycol or ethanol are measured by using a TA instrument Rheometer HR3 and a very specific Rheometric Geometry called “double plate cross hatched”. FIG. 3 shows that the addition of 5% caprylyl glycol to SLES 0.45EO improves the flowability of the sample significantly at both 10° C. and 20° C. FIG. 4 shows that the addition of 5% ethanol to SLES 0.45EO improves the flowability of the sample significantly at both 10° C. and 20° C. The results shows that both caprylyl glycol and ethanol improves the processability (e.g., flowability) of SLES 0.45EO. However, considering the cost, Ethanol is the most cost effective solution for the management of the SLES 0.45EO material.

### Example 3

Several dioxane safe hand dishwashing formulations using SLES 0.45EO having the formulations as indicated in Table 3 are prepared. In the process of preparing these formulations, the addition of caprylyl glycol and/or ethanol to SLES 0.45EO raw materials improves the flowability of the raw materials.

TABLE 3

| ingredient | Comp. 1 | Comp. 2 | Comp. 3 | Comp. 4 | Comp. 5 | Comp. 6 | Comp. 7 |
|---|---|---|---|---|---|---|---|
| SLES 0.45EO | 10 | 10 | 10 | 10 | 10 | 10 | 10 |
| NADDBS | 5.94 | 5.94 | 6.72 | 2.44 | 2.44 | 0 | 0 |
| LMDS | 0 | 0 | 0 | 0 | 0 | 2.44 | 2.06 |
| LAPB | 4.56 | 4.56 | 4.78 | 3.56 | 3.56 | 0 | 0 |
| nonionic surfactant | 1 | 1 | 0 | 0.25 | 0.25 | 0 | 0 |
| CapG and/or ethanol | 2.21 | 2.21 | 0.71 | 0.71 | 0.71 | 0.61 | 0.51 |
| minor ingredients | 2.72 | 2.60 | 3.35 | 2.44 | 2.59 | 2.20 | 2.96 |
| (pH and viscosity | | | | | | | |
| adjusters, fragrances, | | | | | | | |
| colorants, chelants | | | | | | | |
| and preservatives) | | | | | | | |
| water | 75.78 | 75.90 | 75.15 | 81.31 | 81.16 | 86.80 | 87.79 |

While the disclosure has been described with respect to specific examples including presently preferred modes of carrying out the disclosure, those skilled in the art will appreciate that there are numerous variations and permutations of the above described systems and techniques. It is to be understood that other embodiments may be utilized and structural and functional modifications may be made without departing from the scope of the present disclosure. Thus, the scope of the disclosure should be construed broadly as set forth in the appended claims.

1. A cleaning composition comprising one or more anionic surfactants comprising sodium laureth sulfate (SLES), one or more amphoteric surfactants, and an additive selected from caprylyl glycol, ethanol, and a combination thereof, wherein the composition contains less than 1 ppm 1,4-dioxane.

2. The composition of claim 1, wherein the SLES has an average degree of ethoxylation of less than 1.

3. The composition of claim 2, wherein the SLES has an average degree of ethoxylation of from 0.2 to 0.5, optionally wherein the SLES is SLES 0.45 EO (SLES having an average degree of ethoxylation of about 0.45).

4. The composition of claim 1, wherein the SLES is present in an amount of from 5% to 10% by weight of the composition.

5. The composition of claim 1, wherein the one or more anionic surfactants further comprise a linear alkylbenzene sulfonate (LAS).

6. The composition of claim 5, wherein the LAS is sodium dodecylbenzene sulfonate (NADDBS).

7. The composition of claim 6, wherein NADDBS is present in an amount of from 1% to 35% by weight of the composition, optionally wherein NADDBS is present in an amount of from 2% to 7% by weight of the composition

8. The composition of claim 1, wherein the total amount of the one or more anionic surfactants is from 5% to 20% by weight of the composition.

9. The composition of claim 1, wherein the weight ratio of the one or more anionic surfactants to the one or more amphoteric surfactants is from 3:1 to 4:1.

10. The composition of claim 1, wherein the one or more amphoteric surfactants are selected from LMDS (lauryl/myristyl amidopropyl dimethylamine oxide), LAPB (lauryl amido propyl betaine), and a combination thereof.

11. The composition of claim 10, wherein the one or more amphoteric surfactants is LMDS, optionally wherein the pH of the composition is from 6.5 to 8.5, optionally wherein LMDS is present in an amount of from 2% to 5% by weight of the composition.

12. The composition of claim 10, wherein the one or more amphoteric surfactants is LAPB, optionally wherein the pH of the composition is from 3.5 to 8.5, wherein LMDS is present in an amount of from 2% to 5% by weight of the composition.

13. The composition of claim 1, wherein the additive is present in an amount of from 0.1% to 3% by weight of the composition.

14. The composition of claim 1, wherein the additive is caprylyl glycol, optionally wherein caprylyl glycol is present in an amount of from 0.1% to 3% by weight of the composition.

15. The composition of claim 1, wherein the additive is ethanol, optionally wherein ethanol is present in an amount of from 0.1% to 3% by weight of the composition.

16. The composition of claim 1, wherein the composition comprises 7-10% SLES 0.4-0.6 EO (e.g., 0.45 EO), 2-7% NADDBS, 3.5-4.6% LAPB, 0.5-2.3% additive selected from caprylyl glycol, ethanol, and a combination thereof, by weight of the composition.

17. The composition of claim 1, wherein the composition comprises 7-10% SLES 0.4-0.6 EO (e.g., 0.45 EO), 2-2.5% LMDS, 0.5-2.3% additive selected from caprylyl glycol, ethanol, and a combination thereof, by weight of the composition.

18. The composition of claim 1, wherein the composition further comprises an additional ingredient selected from perfumes or fragrances, dyes or pigments, thickening agents, abrasive agents, disinfectants, radical scavengers, bleaches, buffers, chelating agents, and mixtures thereof.

19. The composition of claim 1, wherein the composition is a dishwashing composition.

20. A method of cleaning a hard surface, comprising applying a neat or diluted form of the cleaning composition according to claim 1 to the surface and rinsing the surface with water.
